(19) United States
(12) Patent Application Publication
(10) Pub. No.: US 2017/0166238 A1
(43) Pub. Date: Jun. 15, 2017

(54) STEERING COLUMN FOR VEHICLES

(71) Applicant: A.M.A. S.p.A., San Martino In Rio (IT)

(72) Inventor: Daniele Campana, San Martino in Rio (IT)

(21) Appl. No.: 14/963,872

(22) Filed: Dec. 9, 2015

(51) Int. Cl. B62D 1/184; B62D 1/185

(52) U.S. Cl. CPC B62D 1/184; B62D 1/185

(57) ABSTRACT

A steering column for vehicles has an intermediate shaft, slidingly coupled to a lower shaft connectable with a chassis of a vehicle and rotatably coupled to an upper shaft connectable with a steering wheel of the vehicle, two locking devices to lock the intermediate shaft and, respectively, the upper shaft, and a release crank mounted to move in sequence in a release position of the locking device of the upper shaft and in a release position of the locking device of the intermediate shaft with a movement in a single forward direction.

The present invention relates to a steering column for vehicles.

In particular, the present invention relates to a steering column for vehicles of the type comprising a lower shaft configured to be connected to a chassis of a vehicle; an intermediate shaft, slidingly coupled to the lower shaft to move along a longitudinal axis of the lower shaft; and an upper shaft, which supports a steering wheel of the vehicle and is rotatably coupled to the intermediate shaft to rotate around a rotation axis.

The steering column further comprises a first locking device to lock the intermediate shaft along said longitudinal axis; and a second locking device to lock the upper shaft about said rotation axis.

Generally, the first locking device comprises a braking member, which is carried by the intermediate shaft and is mobile between a locking position and a release position of the lower shaft.

The second locking device usually comprises a first and a second toothed sector, wherein the first toothed sector is fixed to the upper shaft and the second toothed sector is carried by the intermediate shaft. The second locking device is mobile between a locking position, in which the two toothed sectors are coupled, and a release position, in which the two toothed sectors are uncoupled.

The steering column further comprises a release crank hinged to the intermediate shaft close to the steering wheel.

The operator manually moves the release crank between a rest position, a first release position, in which the release crank engages the second toothed segment to move it in its release position, and a second release position, in which the release crank engages the braking member to move it in its release position.

Since the rest position is arranged between the two release positions, the displacements of the release crank from the rest position in the two release positions involve two movements of the release crank in two opposite forward directions, namely downwards and upwards.

### BACKGROUND OF THE INVENTION

The steering columns of the aforesaid known type have some drawbacks mainly deriving from the fact that the release crank can be only manually operated by the operator, and not also by means of an operating pedal coupled to the release crank through a traction cable like, for example, a Bowden cable.

The operating pedal and the traction cable would, in fact, be able to move the release crank only downwards and in one of the two release positions, whereas they would be unable to move the release crank upwards and in the other release position.

### SUMMARY OF THE INVENTION

The object of the present invention is to provide a steering column for vehicles which is free from the aforesaid drawbacks and which is simple and inexpensive to implement.

Therefore, the present invention provides a steering column for vehicles as claimed in the appended claims.

### BRIEF DESCRIPTION OF THE DRAWINGS

The present invention will now be described with reference to the accompanying drawings showing a non-limitative embodiment, in which:

FIG. 1 is a schematic perspective view, with parts removed for clarity's sake, of a preferred embodiment of the steering column of the present invention;

FIG. 2 is a schematic side view, with parts removed for clarity's sake, of the steering column of FIG. 1;

FIG. 3 is a schematic perspective view of a first detail of the steering column of FIGS. 1 and 2;

FIG. 4 is a schematic side view of a second detail of the steering column of FIGS. 1 and 2; and

FIG. 5 is a schematic perspective view of a third detail of the steering column of FIGS. 1 and 2.

### DETAILED DESCRIPTION OF THE INVENTION

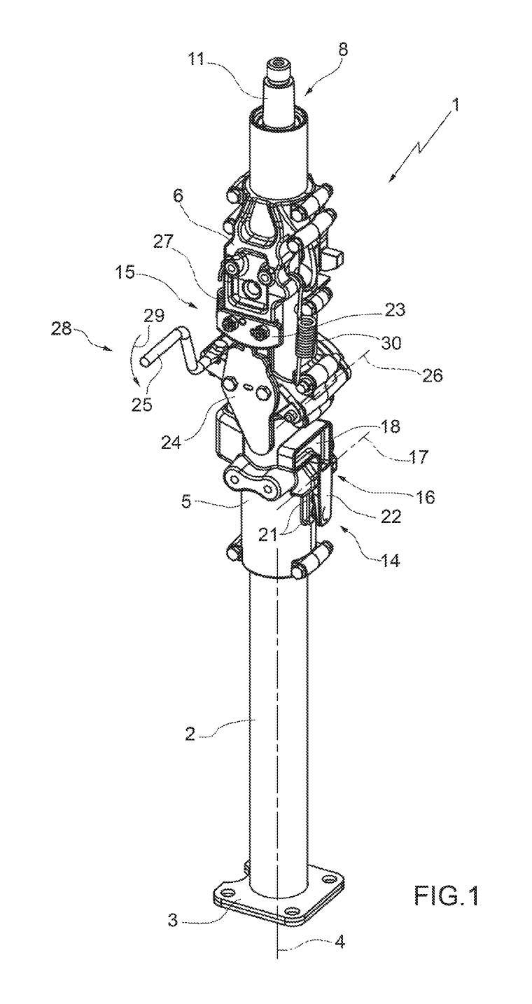

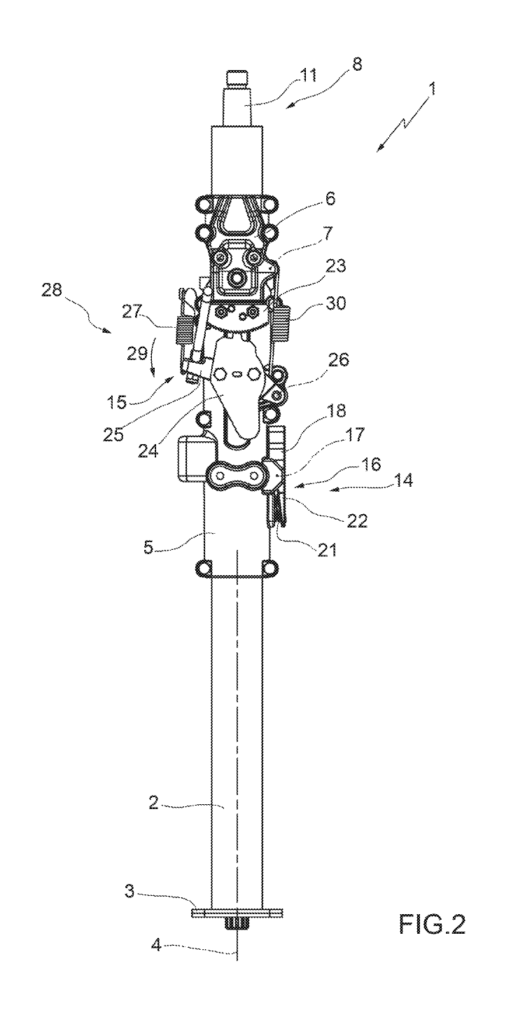

With reference to FIGS. 1 and 2, number 1 indicates, as a whole, a steering column for vehicles comprising a lower shaft 2 adapted to be connected to a chassis (not shown) of a vehicle (not shown) by interposing a coupling plate 3. The shaft 2 has a longitudinal axis 4 and is slidingly engaged by an intermediate shaft 5, which is coaxial to the axis 4, has a tubular shape and extends around the shaft 2. The steering column 1 further comprises an upper shaft 6 rotatably coupled to the shaft 5 to rotate, with respect to the shaft 5, around a rotation axis 7 transverse to the axis 4.

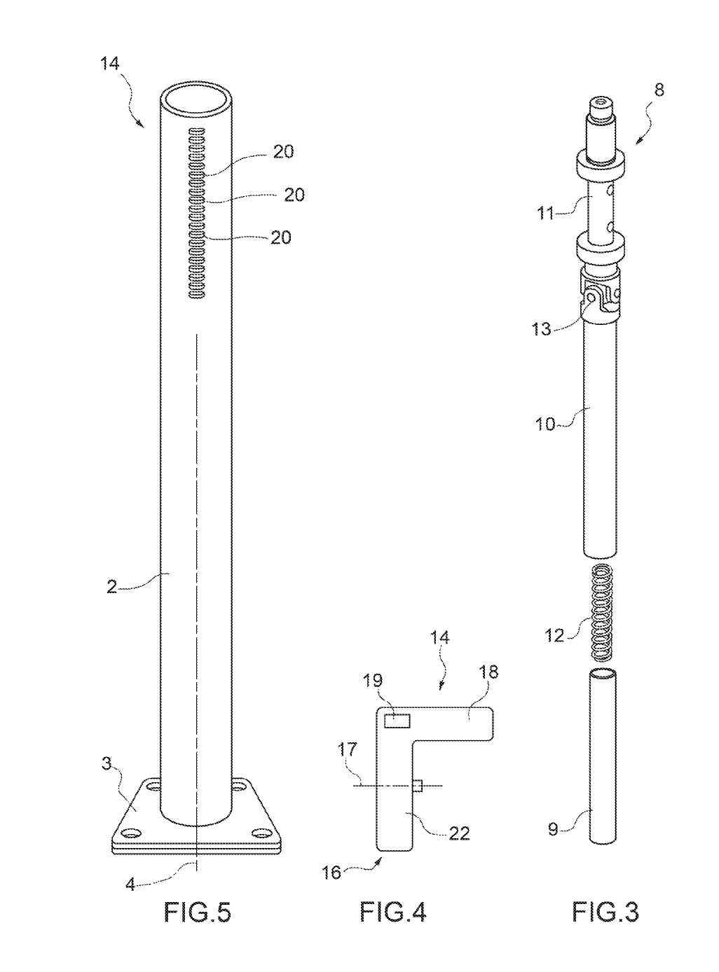

As shown in FIG. 3, the steering column 1 has a drive shaft 8 which extends through the shafts 2, 5, 6, and comprises a bottom portion 9, an intermediate portion 10 and an upper portion 11 which are rotatably and axially fixed engaged to the shafts 2, 5, and, respectively, 6.

The portion 11 has an upper free end projecting outside the shaft 6 for housing and holding a steering wheel (not shown) of the vehicle (not shown).

The portions 9 and 10 are slidingly coupled by interposing a spring 12 mounted coaxially with the axis 4, while the portions 10 and 11 are coupled by means of a shaft coupling 13.

With reference to FIGS. 1 and 2, the steering column 1 further comprises a first locking device 14 for locking the shaft 5 along the axis 4, and a second locking device 15 for locking the shaft 6 around the axis 7.

The device 14 further comprises a rocker 16, which is hinged on the outer surface of the shaft 5 to oscillate, with respect to the shaft 5, about a fulcrum axis 17 which is substantially transverse to the axis 4.

As shown in FIGS. 1, 4 and 5, the rocker 16 has a first arm 18 provided with a tooth 19, which faces the shaft 5 and extends through a slot (not shown) formed through the shaft 5 transverse to the axis 4.

The device 14 further comprises a plurality of recesses 20, which are formed through the shaft 2 transverse to the axis 4, are mutually aligned parallel to the axis 4 and are shaped to house and hold the tooth 19.

The rocker 16 is moved, and usually kept, in a locking position in which the tooth 19 engages one of the recesses 20, by a pair of springs 21 interposed between the shaft 5 and a second arm 22 of the rocker 16.

With reference to FIGS. 1 and 2, the device 15 comprises two toothed sectors 23, 24, wherein the sector 23 is fixed on the outer surface of the shaft 6 and the sector 24 is fixed to a shaped crank 25 hinged to the shaft 5 to rotate, with respect to the shaft 5, around a fulcrum axis 26 which is parallel to the axis 7 and transverse to the axis 4. The sector 24 is moved by the crank 25 about the axis 26 between a locking position, in which the sector 24 engages the sector 23 to lock the shaft 6 around the axis 7, and a release position, in which the sector 24 disengages the sector 23.

The sector 24 is moved, and usually kept in its locking position by a spring 27 interposed between the shaft 5 and the crank 25.

The springs 21, the crank 25 and the spring 27 define an operating device 28 to move the rocker 16 and the sector 24 between the relative locking and release positions.

To this regard, please note that the crank 25 is mounted to move about the axis 26 between a rest position, wherein the rocker 16 and the sector 24 are arranged in the respective locking positions, a first release position, in which the sector 24 disengages the sector 23 and is moved to its release position to adjust the orientation of the shaft 6 around the axis 7, and a second release position, in which the sector 24 engages the arm 18 of the rocker 16 to move it in its release position and to adjust the position of the shaft 5 along the axis 4.

The crank 25 is mounted to move in sequence from the rest position in the first release position and, then, in the second release position by moving about the axis 26 in a single forward direction 29 (counterclockwise in FIG. 1). When the crank 25 is in its first release position, the shaft 6 and, therefore, said steering wheel (not shown) are further mobile in a rest position under the thrust of a spring 30 interposed between the shafts 5 and 6.

Since the direction 29 is oriented downwards and the two devices 14, 15 are released by moving downwards the crank 25, the crank 25 is connectable with an operating pedal (not shown) by interposing a traction cable (not shown), for example a Bowden cable.

The operating device 28 has, therefore, a relatively high versatility, and can be actuated by the operator either manually or through the aforesaid operating pedal.

1. A steering column for vehicles comprising a lower shaft (2), which is configured to be connected to a chassis of a vehicle; an intermediate shaft (5), which is slidingly coupled to the lower shaft (2) to move along a longitudinal axis (4) of the lower shaft (2); an upper shaft (6), which supports a steering wheel of the vehicle and is rotatably coupled to the intermediate shaft (5) to rotate around a rotation axis (7); a first locking device (14) to lock the intermediate shaft (5) along the longitudinal axis (4); a second locking device (15) to lock the upper shaft (6) around the rotation axis (7); each locking device (14, 15) comprising a locking member (18, 24), which is mobile between a relative locking position and a relative release position; and an operating device (28) to move the locking members (18, 24) between the relative locking and release positions, the operating device (28) comprising a release crank (25) to move the locking members (18, 24) from the relative locking positions to the relative release positions; the release crank (25) being mounted so as to move among a rest position, a first release position to release one of the locking members (18, 24) and a second release position to release the other locking member (18, 24); and characterized in that the release crank (25) is mounted so as to move in sequence from the rest position to the first release position and then to the second release position in a single forward direction (29).

2. A steering column according to claim 1, wherein the locking member (24) of the second locking device (15) is fixed to the release crank (25); the movement of the release crank (25) from its rest position to its first release position causing the movement of the locking member (24) of the second locking device (15) to its release position.

3. A steering column according to claim 1, wherein the locking member (18) of the first locking device (14) is mounted inside a forward path of the release crank (25) in said forward direction (29); the movement of the release crank (25) from its first release position to its second release position causing the movement of the locking member (18) of the first locking device (14) to its release position.

4. A steering column according to claim 1 and further comprising at least one first spring (27) to move, and usually keep, the release crank (25) in its rest position.

5. A steering column according to claim 1, wherein the second locking device (15) comprises a first toothed sector (24), which is fixed to the release crank (25) to define the relative locking member (24) and move between the relative locking and release positions, and a second toothed sector (23), which is fixed to the upper shaft (6) to be coupled to the first toothed sector (24).

6. A steering column according to claim 1, wherein the first locking device (14) comprises at least one tooth (18), which is mounted on the intermediate shaft (5) so as to define the relative locking member (18) and move between the relative locking and release positions, and a plurality of recesses (20) formed on the lower shaft (2) along said longitudinal axis (4) to house and hold the tooth (18).

7. A steering column according to claim 6, wherein the tooth (18) is hinged to the intermediate shaft (5) so as to move around a fulcrum axis (17), which is substantially parallel to the rotation axis (7), between the relative locking and release positions.

8. A steering column according to claim 7, wherein the first locking device (14) comprises at least one second spring (21) to move and usually keep the tooth (18) in its locking position.

9. A steering column according to claim 1, wherein the release crank (25) is hinged to the intermediate shaft (5) so as to move around a further fulcrum axis (26), which is substantially parallel to the rotation axis (7), between its rest and release positions.

10. A steering column according to claim 1 and further comprising a drive shaft (8), which extends through the lower, intermediate and upper shafts (2, 5, 6) and comprises, in turn, a lower portion (9), an intermediate portion (10) and an upper portion (11) which are rotatably and axially fixed engaged through the lower shaft (2), the intermediate shaft (5) and the upper shaft (6), respectively.

11. A steering column according to claim 10, wherein the lower portion (9) and the intermediate portion (10) are slidingly coupled by interposing at least one third spring (12), and wherein the intermediate portion (10) and the upper portion (11) are coupled by interposing a shaft coupling (13).

12. A steering column according to claim 1, wherein the forward direction (29) of the release crank (25) from its rest position to its first release position and to its second release position is oriented downwards.
